(19) United States
(12) Patent Application Publication
(10) Pub. No.: US 2026/0159260 A1
(43) Pub. Date: Jun. 11, 2026

(54) VERTICAL BAGGER USING WEB-ALIGNMENT SCORE

(71) Applicant: Pregis LLC, Chicago, IL (US)

(72) Inventor: Thomas D. Wetsch, Naples, FL (US)

(21) Appl. No.: 19/410,645

(22) Filed: Dec. 5, 2025

Related U.S. Application Data
(60) Provisional application No. 63/728,621, filed on Dec. 5, 2024.
(60) Provisional application No. 63/822,082, filed on Jun. 11, 2025.
(60) Provisional application No. 63/823,583, filed on Jun. 13, 2025.

(51) Int. Cl. B65B 9/06; B32B 3/26; B32B 7/12; B32B 27/10; B32B 27/32; B65B 5/02; B65B 5/04; B65B 51/30; B65D 27/00; B65D 65/40

(52) U.S. Cl. CPC B65B 9/06; B65B 5/022; B65B 5/045; B65B 51/30; B65D 27/00; B65D 65/40; B32B 3/263; B32B 7/12; B32B 27/10; B32B 27/32; B32B 2307/304; B32B 2439/46

(57) ABSTRACT

A web for use in forming envelopes has a score line extending along the web in a longitudinal direction of the web and configured to locally reduce a resistance of the web to bending about an axis coinciding with the score line. The decreased bending resistance helps to ensure that longitudinal edge regions of the web are aligned when the longitudinal edge regions are sealed to each other during formation of the envelope on automated bagging machine.

### CROSS-REFERENCE TO RELATED APPLICATIONS

This application claims the benefit under 35 U.S.C. § 119(e) of U.S. Application No. 63/728,621, filed Dec. 5, 2024; U.S. Application No. 63/822,082, filed Jun. 11, 2025; and U.S. Application No. 63/823,583, filed Jun. 13, 2025. The contents of each of these applications are incorporated by reference herein in their entireties.

### BACKGROUND

Automated bagging machines are in widespread use to package small to medium size items in shipping envelopes. Some types of automated bagging machines are configured to form shipping envelopes by folding a web of plastic film or paper. The item to be packaged can be inserted between the overlapping portions of the folded web. The overlapping longitudinal edge regions of the web, and the overlapping transverse portions of the web are then sealed to fully form the envelope, and to contain the item within the envelope. The loaded and sealed envelope then can be separated from the remainder of the web by cutting or other techniques.

The longitudinal edges of the web need to be aligned as they as sealed, to help ensure that a satisfactory seal is formed. Achieving the necessary degree of alignment between the edges in a high-speed automated bagging machine, however, can be difficult, and often requires the use of multiple sensors and alignment features to maintain the web in alignment with its intended path through the bagging machine. These sensors and alignment features can increase the overall cost and complexity of the bagging machine.

### SUMMARY

In one aspect of the disclosed technology, a system for forming envelopes includes a web having a score line extending along the web in a longitudinal direction of the web and configured to reduce a resistance of the web to bending about an axis coinciding with the score line.

The system also includes a bagging machine having a folder including a former configured to fold the web as the web is drawn over the folder, and a web guide located downstream of the former and having opposing guide surfaces configured to urge longitudinal edges of the envelope toward each other to further fold the web as the web passes through the web guide so that a first portion of the web overlaps a second portion of the web to form an envelope pocket of an envelope. The system also includes a sealing device having two opposing sealing surfaces configured to apply a sealing pressure to a sealing area on the web to form a seal between the first and second portions of the web.

In another aspect of the disclosed technology, the score line is configured to cause the web to fold about the score line as the web is drawn over the former and through the web guide.

In another aspect of the disclosed technology, the score line defines a living hinge on the web.

In another aspect of the disclosed technology, a thickness of the web is locally reduced along the score line.

In another aspect of the disclosed technology, the portion of the web of having the reduced thickness defines a valley.

In another aspect of the disclosed technology, the score line is one or more of a cut, a crease, a fold, an abrasion, a sealed region, and a crushed region.

In another aspect of the disclosed technology, the first and second portions of the web each have a width in a direction transverse to the longitudinal direction of the web, and the width of the first portion of the web is about equal to the width of the second portion of the web.

In another aspect of the disclosed technology, the score line is configured to cause the longitudinal edges of the web to align when the web is folded about the score line as the web is drawn over the former and through the web guide.

In another aspect of the disclosed technology, the score line is located along a longitudinal centerline of the web.

In another aspect of the disclosed technology, the score line causes the longitudinal edges of the web to align when the web is folded about the score line as the web is drawn over the former and through the web guide while web and the former are misaligned.

In another aspect of the disclosed technology, the score line causes the longitudinal edges of the web to align when the web is folded about the score line as the web is drawn over the former and through the web guide while a longitudinal centerline of the web and a centerline of the former are misaligned.

In another aspect of the disclosed technology, the sealing area includes longitudinal edge regions of the web, the longitudinal edge regions being adjacent to respective longitudinal edges of the web.

In another aspect of the disclosed technology, the sealing area further includes transverse regions extending orthogonally to the longitudinal edge regions.

In another aspect of the disclosed technology, the web includes a bonding element located in the sealing area and configured to form the seal between the first and second portions of the web.

In another aspect of the disclosed technology, the bonding element is a heat-activatable material, and the bagging machine further includes a heating element configured to apply sufficient heat to the sealing area to activate the heat-activatable material.

In another aspect of the disclosed technology, the web includes paper.

In another aspect of the disclosed technology, the web includes a first layer, a second layer, and a third layer, the second layer is positioned between the first and third layers, and the first, second, and third layers are compressed along the score line.

In another aspect of the disclosed technology, the first, second, and third layers are sealed to each other along the score line.

In another aspect of the disclosed technology, the first, second, and third layers include plastic film.

In another aspect of the disclosed technology, the second layer includes a plurality of fluid-filled bubbles.

In another aspect of the disclosed technology, the second layer is positioned between the first and third layers and includes padding or a thermally insulating material, and the padding or thermally insulating material is crushed along the score line.

In another aspect of the disclosed technology, the folder further includes a forming guide located on the former and configured to engage the web, and the score line and forming guide cooperate to center the web on the folder.

In another aspect of the disclosed technology, the score line is configured to track the forming guide.

In another aspect of the disclosed technology, a bagging machine is provided for forming envelopes from a web having a score line extending along the web in a longitudinal direction of the web and configured to reduce a resistance of the web to bending about an axis coinciding with the score line. The bagging machine includes a folder including a former, and a forming guide located on the former and configured to engage the web. The former and the forming guide are configured to fold the web as the web is drawn over the former.

The bagging machine also includes a web guide located downstream of the former and having opposing guide surfaces configured to urge longitudinal edges of the envelope toward each other to further fold the web as the web passes through the web guide so that a first portion of the web overlaps a second portion of the web to form an envelope pocket of an envelope.

The bagging machine further includes a sealing device having two opposing sealing surfaces configured to apply a sealing pressure to a sealing area on the web to form a longitudinal seal and a transverse seal between the first and second portions of the web.

In another aspect of the disclosed technology, the forming guide is configured to engage the web at and proximate the score line.

In another aspect of the disclosed technology, the forming guide is configured to exert a force on the web in a direction transverse to the longitudinal direction of the web when the score line and the forming guide are misaligned in the transverse direction.

In another aspect of the disclosed technology, the forming guide extends along a longitudinal centerline of the former.

In another aspect of the disclosed technology, the forming guide is configured to elevate the web in relation the former.

In another aspect of the disclosed technology, the forming guide projects from an upper surface of the former.

In another aspect of the disclosed technology, the forming guide is located on a downstream end of the former.

In another aspect of the disclosed technology, the former has a substantially triangular shape, and the forming guide is located at a vertex of the former.

In another aspect of the disclosed technology, a downstream end of the forming guide is rounded.

In another aspect of the disclosed technology, an upstream end of the forming guide has a substantially straight top surface angled upwardly along the downstream direction.

In another aspect of the disclosed technology, the forming guide has a length in the downstream direction, and a thickness in a direction transverse to the downstream direction. A ratio of the length to the thickness of the forming guide is about 10:1 or greater.

In another aspect of the disclosed technology, the forming guide has a thickness in a direction transverse to the downstream direction, and the thickness of the forming guide is about 1/16-inch to about ¾-inch.

In another aspect of the disclosed technology, a method for forming an envelope includes providing a web including a score line extending along the web in a longitudinal direction of the web and configured to reduce a resistance of the web to bending about an axis coinciding with the score line. The method also includes folding the web about the score line so that a first portion of the web overlaps a second portion of the web to form an envelope pocket of the envelope, and forming a longitudinal seal between a longitudinal edge region on the first portion of the web and a longitudinal edge region on the second portion of the web.

In another aspect of the disclosed technology, the method further includes forming a transverse seal between the first and second portions of the web.

In another aspect of the disclosed technology, the method further includes folding the web about the score line so that longitudinal edges of the web align.

In another aspect of the disclosed technology, the method further includes drawing the web over a folder including a former configured to fold the web.

In another aspect of the disclosed technology, the method further includes drawing the web over the folder while the score line and a longitudinal centerline of the former are misaligned.

In another aspect of the disclosed technology, the folder further includes a forming guide configured to cooperate with the web to center the web on the former, and the method further includes drawing the web over the folder as the score line tracks the forming guide to align the score line and the longitudinal centerline of the former.

In another aspect of the disclosed technology, the method further includes placing an item in the envelope pocket before forming the longitudinal seal.

In another aspect of the disclosed technology, a web configured for use with a bagging machine includes a score line extending along the web in a longitudinal direction of the web and configured to reduce a resistance of the web to bending about an axis coinciding with the score line.

In another aspect of the disclosed technology, the web includes a bonding element configured to form a longitudinal seal between overlapping longitudinal edge regions of the web when the web is folded about the score line.

In another aspect of the disclosed technology, the web includes a first layer, a second layer, and a third layer. The second layer is positioned between the first and third layers, and the first, second, and third layers are sealed to each other along the score line.

In another aspect of the disclosed technology, the first, second, and third layers include plastic film.

In another aspect of the disclosed technology, the second layer includes a plurality of fluid-filled bubbles.

In another aspect of the disclosed technology, the web further includes a first layer, a second layer, and a third layer. The second layer is positioned between the first and third layers and includes padding or a thermally insulating material, and the padding or thermally insulating material is crushed along the score line of the web.

In another aspect of the disclosed technology, the score line is one or more of a cut, a crease, a fold, an abrasion, a sealed region, and a crushed region.

In another aspect of the disclosed technology, a method of making a supply unit of a web for use in a bagging machine includes providing a sheet material, applying a heat-activatable material to the sheet material, forming a score line in the sheet material, and forming the sheet material into a high-density configuration.

In another aspect of the disclosed technology, the heat-activatable material is a heat-sealable material.

In another aspect of the disclosed technology, forming the sheet material into a high-density configuration includes forming the sheet material into a rolled configuration.

In another aspect of the disclosed technology, forming the sheet material into a high-density configuration includes folding the sheet material into a fan-fold configuration.

In another aspect of the disclosed technology, forming a score line in the sheet material includes cutting, creasing, folding, abrading, sealing, deforming, and/or crushing the sheet material.

In another aspect of the disclosed technology, the method further includes forming the score line along a longitudinal centerline of the sheet material.

In another aspect of the disclosed technology, the sheet material is paper.

In another aspect of the disclosed technology, the sheet material includes a first and a second layer of paper.

In another aspect of the disclosed technology, the method further includes forming the sheet material into the high-density configuration after applying the heat-activatable material and forming the score line.

In another aspect of the disclosed technology, supply unit of a web for use in a bagging machine is formed in accordance with the above method.

### BRIEF DESCRIPTION OF THE DRAWINGS

The following drawings are illustrative of particular embodiments of the present disclosure and therefore do not limit the scope of the present disclosure. Embodiments of the present disclosure will hereinafter be described in conjunction with the appended drawings, wherein like numerals denote like elements.

FIG. 1 is a perspective view of an embodiment of a web;

FIG. 2 is a front view of the web shown in FIG. 1;

FIG. 3 is an embodiment of a forming device for forming the web shown in FIGS. 1 and 2.

FIG. 4 is a perspective view of an alternative embodiment of the web shown in FIGS. 1-3;

FIG. 5 is a front view of the web shown in FIG. 4;

FIG. 6 is an embodiment of a forming device for forming the web shown in FIGS. 4 and 5;

FIG. 7 is an embodiment of a bagging machine for use with webs shown in FIGS. 1-3 and 4-6;

FIG. 8 is a rear view of the bagging machine shown in FIG. 7;

FIG. 9 is an alternate view of the bagging machine shown in FIG. 7 taken from the perspective of viewpoint labeled IX in FIG. 7;

FIG. 10 is a rear perspective view of an alternative embodiment of a folder of the bagging machine shown in FIGS. 7-9; and

FIG. 11 is a side view of the former shown in FIG. 10.

### DETAILED DESCRIPTION

The inventive concepts are described with reference to the attached figures, wherein like reference numerals represent like parts and assemblies throughout the several views. Several aspects of the inventive concepts are described below with reference to example applications for illustration. It should be understood that numerous specific details, relationships, and methods are set forth to provide a full understanding of the inventive concepts. One having ordinary skill in the relevant art, however, will readily recognize that the inventive concepts can be practiced without one or more of the specific details or with other methods. In other instances, well-known structures or operations are not shown in detail to avoid obscuring the inventive concepts.

Packaging containers can include parcel packaging and other containers to package items. Packaging containers are configured to contain and hold an item, typically enclosing the item, during shipping or storage of the item. Parcel packaging is configured for shipping and/or storing products, such as for storage in warehouses or retail shelves and displays. Examples of parcel packaging include flexible shipping containers such as envelopes, which can have varying degrees of flexibility and typically are used to ship or mail small or relatively flat items or smaller items around which the walls of the envelope can conform. Flexible shipping containers such as envelopes can be padded or non-padded, can be made of materials such as paper and flexible cardboard, can be configured with or without sidewalls or gussets, and can include larger envelopes such as mailers. Examples of parcel packaging also include bags, such as paper or poly bags, which can have a self-sealing capability and are typically used to ship small to medium-sized items; boxes, which can be formed from paperboard, cardboard, wood, or plastic, and typically have a rigid or semi-rigid structure suitable for holding medium to large-size items and heavier items; and shipping tubes or tube mailers, typically used to ship documents and paper items.

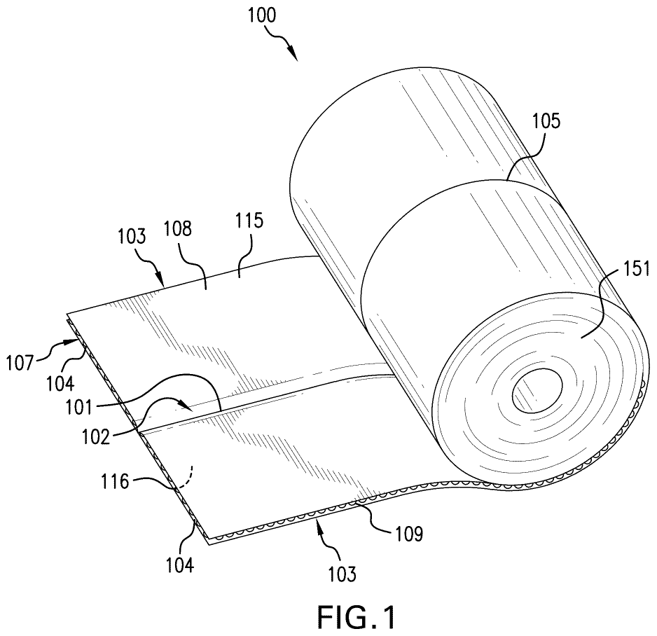

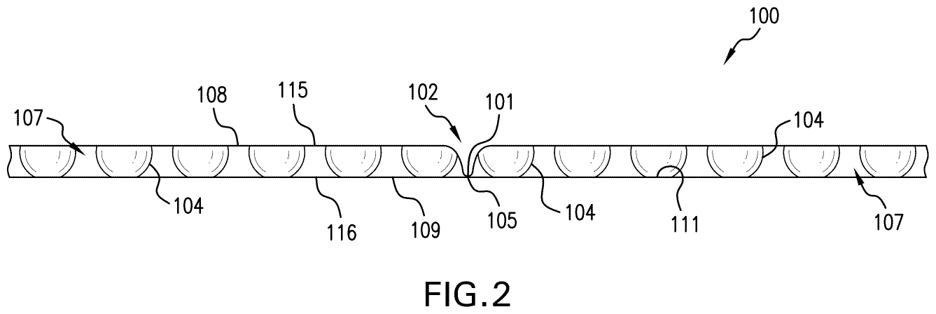

FIGS. 1-3 show a web 100. As can be seen in FIG. 2, the web 100 includes multiple layers. In particular, the web 100 includes a first layer 107, a second layer 108, and a third layer 109. The first, second, and third layers 107, 108, 109 can be formed, for example, from a plastic film such as polyethylene film. The first layer 107 can have semi-spherical bubbles 104 formed thereon. The bubbles 104 can be formed, for example, by thermoforming or vacuum forming of the first layer 107 with a die or other suitable forming apparatus. The second layer 108 then can be fixed to the side of the first layer 107 from which the bubbles 104 extend to seal the bubbles 104 and trap a fluid, such as air, within the bubbles 104 thereby creating fluid-filled chambers or cushions. The third layer 109 is applied to crowns 111 of the bubbles 104.

The web 100, and alternative embodiments thereof, can be formed from materials other than plastic film. For example, the web 100, and alternative embodiments thereof, can be formed from one or more layers of regular kraft paper, extensible paper, newsprint, cellulose and starch compositions, or other types of paper. The paper can have a basis weight of, for example, about 20 lbs. to about 100 lbs. per 3,000 square feet, and can be virgin or recycled paper. The web 100 can be configured as a ribbon of sheet material that is stored in a rolled, fan-folded, or other suitable configuration. The web 100 can be stored and shipped in a high-density configuration, such as a roll or a fan-folded configuration, and can be converted to a low-density configuration prior to being formed into envelopes.

Alternative embodiments of the web 100 can include more, or less than three layers. In some alternative embodiments, the middle or other intermediate layer can be a layer of padding. In some embodiments, the padding can include a material configured to expand when subjected to elevated temperatures or other conditions, allowing the web 100 to be stored and shipped in a high-density configuration and converted to a low-density configuration prior to use.

A score line 101 extends along the longitudinal centerline of the web 100 in the machine direction i.e., the longitudinal direction of the web 100. The score line 101 can be formed, for example, by a cut, a deformation, a fold, crushing, creasing, sealing, abrasion, or other technique that locally reduces the bending stiffness of the web 100 about its longitudinal centerline. The score line 101 thus functions as a living hinge that encourages folding of the web 100 about its longitudinal centerline. In alternative embodiments formed of multiple layers of paper or other cellulosic materials, the score line 101 can be formed, for example, by cutting through one or more, but not all, of the paper layers.

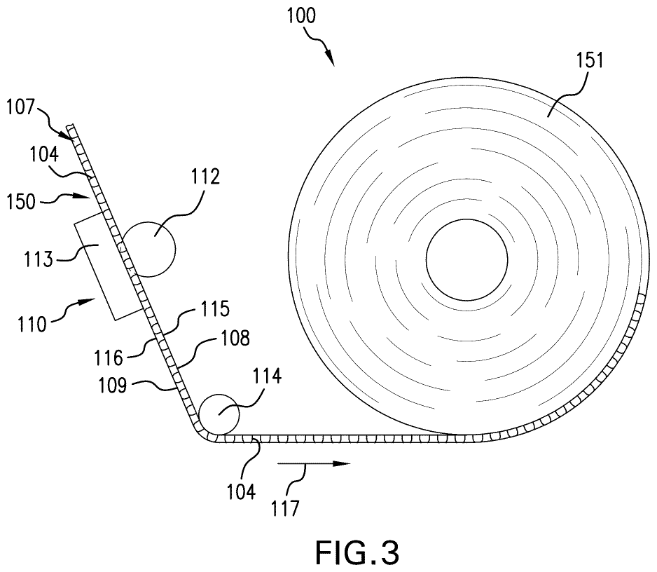

A forming device 110, shown in FIG. 3, can be used to form the score line 101 in the web 100. The forming device 110 can include, for example, a heated roller 112 and an anvil 113. A web forming supply 150 of the web 100 in a pre-formed configuration, i.e., with first, second, and third layers 107, 108, 109 stacked and aligned with each other, is fed to the forming device 110 between the roller 112 and the anvil 113. The roller 112 applies pressure and heat to locally deform the pre-formed web 100 and thereby form the score line 101. The score line 101 thus is formed without cutting or severing the pre-formed web 100. In alternative embodiments, the score line 101 can be formed by cutting or severing the pre-formed web 100.

The web 100 can be consolidated in a high-density configuration, such as a rolled or fan-folded configuration. Alternatively, forming devices such as the forming device 110 can be incorporated into bagging machines, such as the bagging machine 302 described below, so that the web 100 can be formed on the bagging machine on which the web 100 is used to form envelopes.

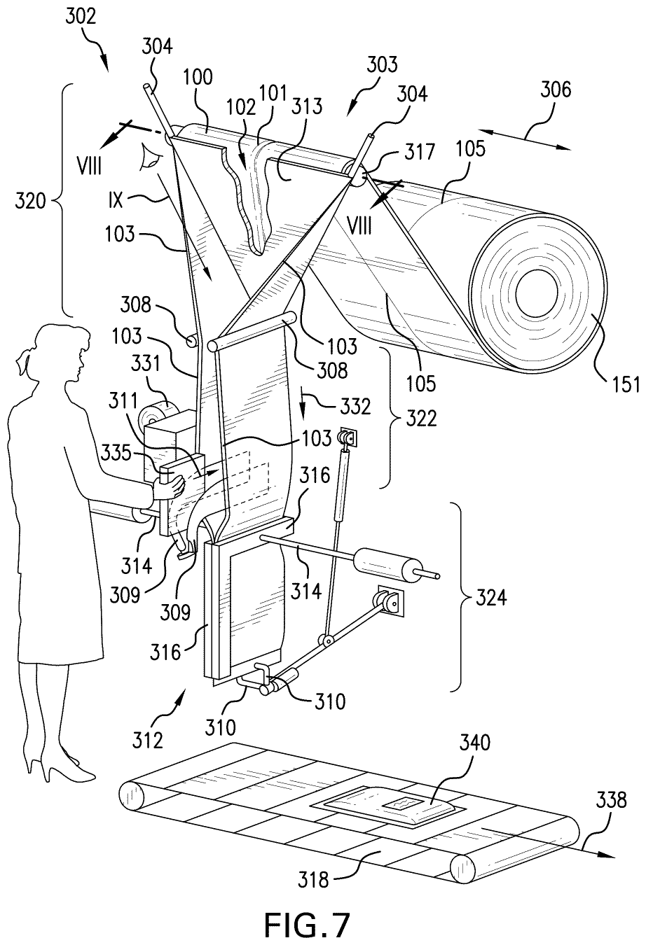

As can be seen in FIG. 2, the score line 101 extends inwardly from a first side 115 of the web 100 because the first and second layers 107, 108 have been displaced and heat sealed to the third layer 109 along the longitudinal centerline of web 100 by contact with roller 112, with the resulting heat seal 105 between the first, second, and third layers 107, 108, 109 being visible in FIGS. 2 and 7. A second side 116 of the web 100 (corresponding to the third layer 109), which was in contact with the anvil 113, has remained substantially flat. The web 100 thus is locally thinned along the score line 101 due to the displacement of the first and second layers 107, 108 into the third layer 109, with the local thickness of the web 100 equal to the combined thickness of the films from which first, second, and third layers 107, 108, 109 are formed; and with the inwardly-displaced portion of the first layer 107 defining a valley 102 adjacent the score line 101.

After the score line 101 has been formed, the web 100 is directed by a roller 114 of the forming device 110 into a supply roll configuration 151, as shown in FIG. 3. The roller 114 contacts the side 115 of the newly formed web 100 to direct the web 100 into the supply roll configuration 151. In alternative embodiments, the web 100 can be manipulated into other supply configurations, such as a fan-folded stack.

In applications where the web 100 is formed from paper or other materials that cannot be welded together by the application of heat, a bonding element can be used to fix the first and second layers 107, 108 to the third layer 109. For example, a heat activable material, such as a hot-melt adhesive or a heat-sealable material, can be applied to one or more of the first, second, and third layers 107, 108, 109. The heat-activatable material, upon being activated by the application of heat and pressure by the roller 112, forms a bond that fixes the first and second layers 107, 108 to the third layer 109. In applications where the intermediate layer or layers, e.g., the first layer 107, is formed from padding or thermally-insulating material, the intermediate layer or layers can be crushed or otherwise deformed along the longitudinal centerline of web 100 to form the score line 101, without fixing the second layer 108 and the intermediate layers to the third layer 109.

Alternative embodiments of the forming device 110 can have configurations other than that described above. For example, alternative embodiments of the forming device 110 can be configured to form a score line using a cutting blade, an abrasive member, a creaser, a heated wire, a press, etc.

Hot-melt adhesives are thermoplastic polymers that are solid at room temperature, become molten when heated to an activation temperature above their softening point, and resolidify upon loss of heat at a temperature below a solidifying point, which may be the same as or different than the activation temperature, increasing in strength as they re-solidify. Most hot-melt adhesives, upon melting into a molten state and re-solidifying, do not undergo any chemical reaction such as cross-linking or removal of a carrier, e.g., evaporation of water. Thus, hot-melt adhesives typically can be reactivated, i.e., re-melted and re-solidified, after initially being applied to a substrate.

The hot-melt adhesive, after being applied to the surface to be bonded, can be in a low-tackiness state in which it has a low, or no tackiness in a lower range of temperatures. The hot-melt adhesive is reactivatable. More specifically, the hot-melt adhesive is applied hot, and cools and cures in the converting process. The hot-melt adhesive is reactivated by re-heating the hot-melt adhesive up to an activation temperature within a lower range of temperatures. This lower range of application temperatures in some embodiments, for example, is below about 140° F. In other embodiments, for example, the lower range of temperatures is below about 120° F., below about 125° F., or below about 130° F. The adhesive coating weight will affect activation temperature.

The re-heating of the hot-melt adhesive to the activation temperature causes the hot-melt adhesive to become molten. The subsequent cooling of the hot-melt adhesive, in combination with the application of pressure, causes the hot-melt adhesive to bond to the opposing surface, forming a seal between the surfaces.

A heat seal typically is formed by sealing one thermoplastic to the same or a similar thermoplastic. The thermoplastic material(s) typically is applied to the two substrates to be fixed to each other. At the time the substrates are to be fixed, the thermoplastic material(s) on one or both substrates is subject to heat and pressure sufficient to weld the materials together, thereby fixing the substrates to each other.

The heat-activatable material can be, for example, a heat sealable material. Heat sealable materials are pre-applied on the opposing surfaces of the substrates that are to be sealed together, typically as a coating applied to each surface. In some embodiments, the heat sealable material can be applied as a tape. The heat sealable material, after application, typically is solid in form.

An example of a heat sealable coating material is a weldable polymer provided in a thickness and with a composition such that upon applying sufficient heat to the coating and pressure to the substrates to pressure the opposing coatings against each other, the heat sealable material of the coatings melts and becomes welded together upon cooling, thereby forming a heat-seal of one substrate to the other. Typical heat sealable coatings are made of thermoplastic components. The heat sealable material on the opposing surfaces of the substrates typically is identical. In some embodiments, non-identical materials can be used in the coating provided the materials are sufficiently compatible such that the materials can melt and combine to become welded together upon cooling.

In some embodiments, the heat-sealable material can include emulsion-based polymers and polymer dispersions that dry to form heat sealable coatings. The one or more polymers can include one or more of vinyl acetate ethylene, polyvinyl acetate, polyvinyl alcohol, polyvinyl acetate copolymers, polyvinyl alcohol copolymers, dextrin stabilized polyvinyl acetate, vinyl acetate copolymers, ethylene copolymers, vinylacrylic, styrene acrylic, acrylic, styrene butyl rubber, polyurethane, polyolefins, and biodegradable materials (e.g., cellulose and starch). For example, the heat-activatable sealable material can be a polyvinyl alcohol (PVOH) coating. In some applications, the PVOH can be coated with polyethylene (PE) or polylactic acid (PLA) to prevent the PVOH from sticking, or from absorbing moisture which causes sticking.

In some embodiments, the heat-sealable material can include a polyolefin-based dispersion. The polyolefin dispersion can include polyethylene and/or polypropylene, thermoplastic polymers, polymeric stabilizing agents including at least one polar polymer, water, and/or other suitable polyolefin dispersions. A suitable polyolefin dispersion can include, for example, HYPOD™, available from Dow Chemical, or other suitable polyolefin dispersions.

In some embodiments, the heat-sealable material can be water-based. The water-based heat-sealable material may include a water-based polymer. The use of a water-based heat-sealable material can enhance the recyclability of the envelope 120, since the water-based heat-sealable material can be dissolved and separated easily from the paper pulp during the recycling process.

As another example, the heat-activatable sealable material can be an expandable material that expands when subjected to an elevated temperature. The expandable material, when expanded, can provide an additional cushioning effect. For example, an expandable material can be provided by depositing an expansion element on to the surface of a fluid adhesive. When activated, the expansion element creates voids in the adhesive, producing a foamed adhesive. Microspheres filled with a gas, such as nitrogen, for example, can be used as the expansion element. When heated, such as by subjecting the microspheres to microwave or other radiation, the expandable material expands and can provide a cushioning effect.

A cohesive material includes a bonding material that causes one surface to stick to an opposing surface by coming into contact with the same or a complimentary cohesive substance to form the bond between the two surfaces. Cohesives, such as contact adhesives, do not stick to other substances sufficiently to adhere to those other substances, or in some cases stick very weakly compared to the bond they form from sticking to each other.

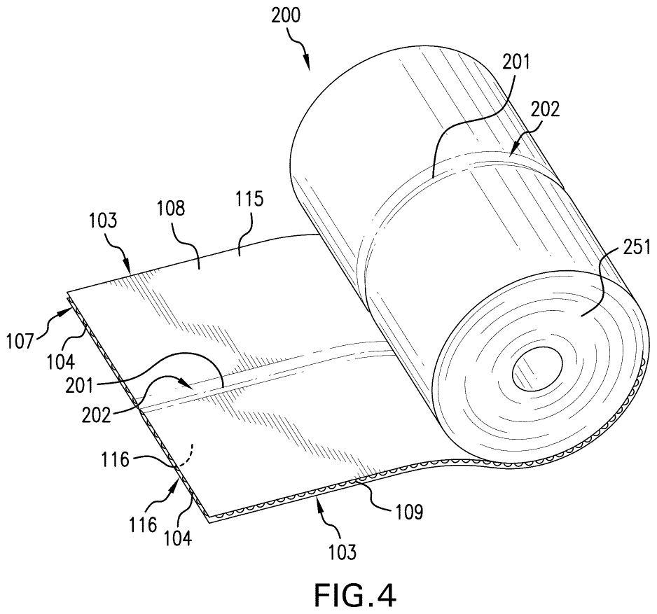

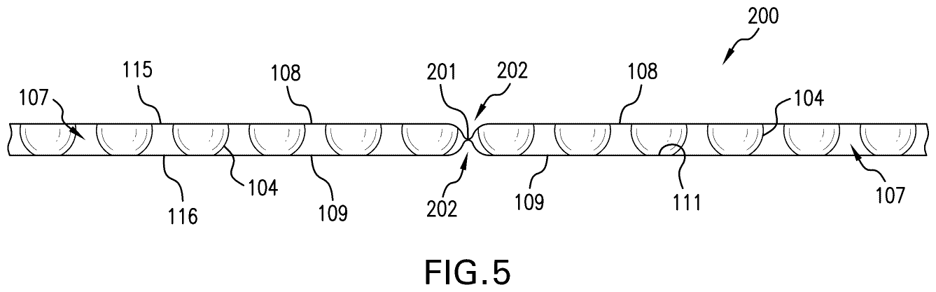

FIGS. 4 and 5 show an alternative embodiment of web 100 in the form of a web 200. The above description of the web 100 applies equally to the web 200, unless otherwise noted.

A score line 201 extends along the longitudinal centerline of the web 200 in the machine direction i.e., along the longitudinal direction of the web 200. The score line 201 can be formed, for example, by a cut, a deformation, a fold, crushing, sealing, or other technique that locally reduces the bending stiffness of the web 200 about its longitudinal centerline. The score line 201 thus functions as a living hinge that encourages folding of the web 200 about its longitudinal axis.

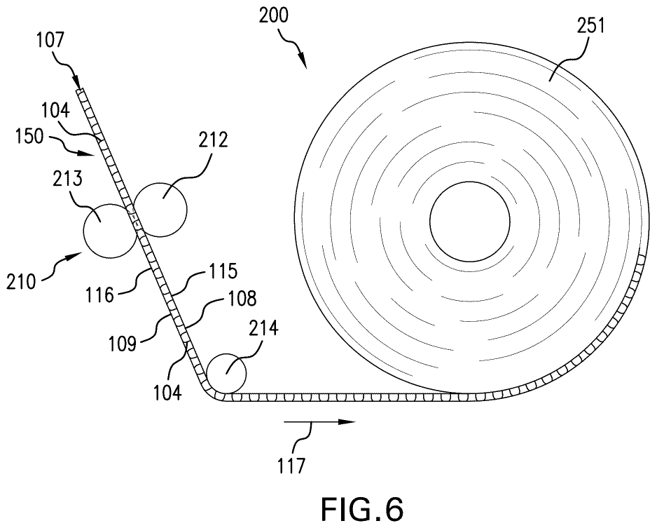

FIG. 6 depicts an alternative embodiment of the forming device 110 in the form of a forming device 210. The forming device 210 includes rollers 212, 213, with one or both of the rollers 212, 213 being a heated roller. The forming device 210 is similar to forming device 110, with the exception that the forming device 210 includes the roller 213 in lieu of the anvil 113 of the forming device 110. A supply 150 of the web 200 in a pre-formed configuration, i.e., with first, second, and third layers 107, 108, 109 stacked and aligned with each other, is fed to the forming device 210 between the roller 212 and the roller 213. The rollers 212, 213 apply heat and pressure to locally deform the pre-formed web 200 and thereby form the score line 201. The score line 201 thus is formed without cutting or severing the pre-formed web 200.

As can be seen in FIG. 5, the score line 201 extends inwardly from both a first side 115 and second side 116 of the formed web 200, because the second layer 108 and the third layer 109 both have been displaced toward each other, and the first layer 107, second layer 108, and third layer 109 have been welded (heat sealed) to their respective adjacent layer or layers along the longitudinal centerline of web 200 by contact with the rollers 212, 213.

After the score line 201 has been formed, the web 200 is directed by a supplemental roller 214 of forming device 210 into a supply roll configuration 251, as shown in FIG. 6. The supplemental roller 214 contacts the first side 115 of the newly formed web 200 to direct the web 200 into the supply roll configuration 251. In alternative embodiments, the web 200 can be folded into other supply configurations, such as a fan-folded stack.

Alternative embodiments of the web 100 and the web 200 can be formed with more than one of the respective score lines 101, 201. For example, an alternative embodiment of the web 100 can be formed with two of the score lines 101 so that the web 100 can be folded about two fold lines to form an envelope in which the side edges overlap along the approximate center of a rear wall of the envelope. An alternative embodiment of the web 200 likewise can be formed with two of the score lines 201 so that the web 200 can be folded about two fold lines to form an envelope in which the side edges overlap along the approximate center of a rear wall of the envelope. In such embodiments, the score lines 101, 201 would not be coincident with the longitudinal centerline of the respective webs 100, 200.

FIG. 7 depicts a bagging machine 302 configured to convert the web 100 or the web 200 into a C-folded configuration, and to seal the folded structure around an item 335 to be packaged to form a closed envelope 340. For clarity, the bagging machine 302 is described herein in connection with the web 100. The following description applies equally to the web 200 and other alternative embodiments of the web 100, and other types of scored webs. The web 100 can be supplied, for example, in the supply roll configuration 151 depicted in FIG. 3. The web 100 can be supplied in other configurations, such as a fan-folded stack, in the alternative.

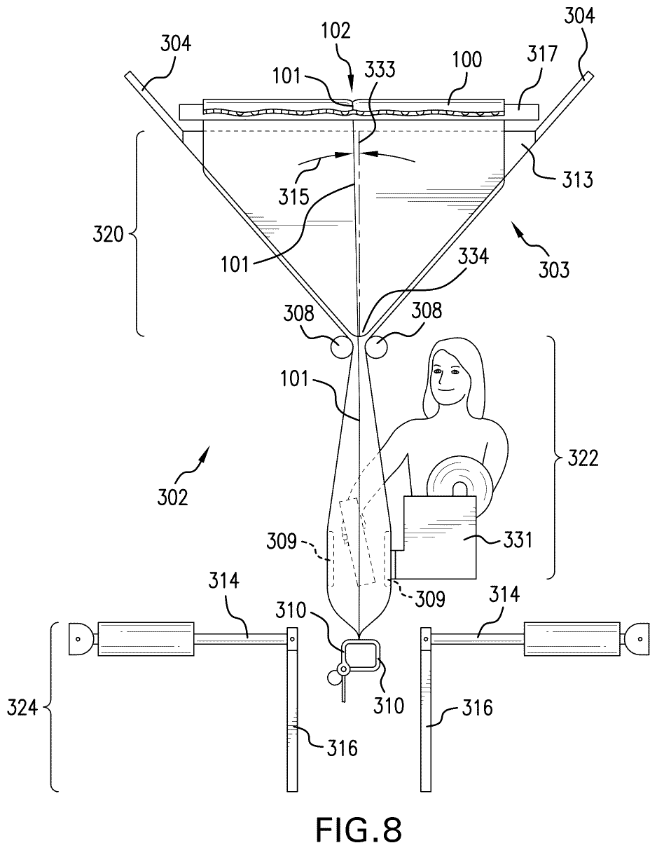

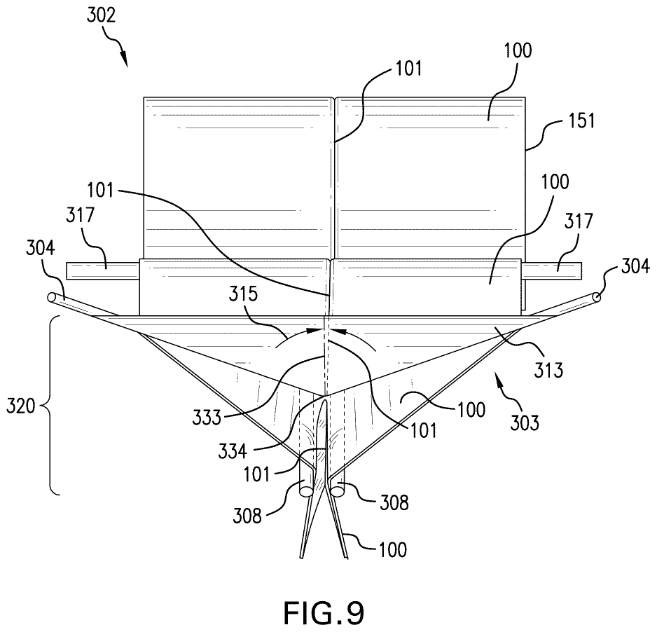

The bagging machine 302 includes a folder 303. The folder 303 is depicted in FIG. 7 in a partial cutaway view, for clarity. The folder 303 includes a former 313, and angled guides 304 that extend from an upper portion of the former 313. The former 313 has a generally triangular configuration, with a pointed vertex 334 at the bottom thereof. A centerline 333 of the former 313 is denoted in FIGS. 8 and 9 by the reference numeral 333.

The bagging machine 302 also includes a roller 317 positioned proximate to an upper end of the former 313. The web 100 is drawn from the supply roll 151 and over the roller 317, at which point the web 100 is turned so as to move in a generally downward direction and into contact with the former 313, with the guides 304 helping to guide the web 100 onto the former 313. The web 100 then is drawn downward over the rearward side of the former 313 (from the perspective of FIG. 7), in the direction denoted by the arrow 332. The bagging machine 302 is equipped with a dancer or similar equipment configured to adjust tension in the web 100. Alternative embodiments of the bagging machine 302 can be equipped without this feature. The bagging machine 302 is equipped with sensors positioned along the path of the web 100 to monitor the lateral alignment of the web 100 with its intended path. Alternative embodiments of the bagging machine 302 can be equipped without this feature.

The bagging machine 302 further includes two opposing, closely-spaced guides 308 located downstream of the folder 303. An intermediate area 320 of the bagging machine 302 is defined between the guides 304 and the guides 308. The bagging machine 302 includes one or more drive rollers (not shown) to drive the web 100 from the supply roll 151 into the intermediate area 320. Alternative embodiments of the bagging machine 302 can be equipped without this feature.

The web 100, which is partially folded as it moves over the former 313 of the folder 303, is drawn between the guides 308 upon leaving the folder 303. The closely-spaced guides 308 urge the opposing sides of the web 100, i.e., the sides of the web 100 on opposite sides of the fold line that begins to form as the web 100 moves over the former 313, toward each other, further folding the web 100 into the C-folded configuration as shown in FIGS. 7 and 8. At this point, the opposing walls of the envelope 340 have been pre-formed, with an envelope pocket being defined between the opposing walls. As discussed below, the envelope pocket receives the item 335 to be packaged within the envelope 340.

As discussed below, the longitudinal edge regions of the folded web 100 (which correspond to the portions of the web 100 adjacent to the longitudinal edges 103) are sealed to each other after the item 335 to be packaged has been placed within the envelope pocket. The longitudinal edges 103 thus need to closely align when the web 100 is folded, to help ensure that the seal between the longitudinal edge regions is formed properly. This in turn requires the web 100 to be folded about its longitudinal centerline, with the pre-formed opposing walls of the envelope 340 having about the same dimensions in a direction transverse to the downstream direction. Because the score line 101 in the web 100 locally reduces the resistance of the web 100 to bend or fold about its longitudinal centerline, the score line 101 encourages the web 100 to fold about its longitudinal centerline and thus helps to ensure that the longitudinal edges 103 of the folded web 100 properly align.

FIG. 9 is taken from the viewing perspective denoted by the symbol IX in FIG. 7. FIG. 9 depicts the web 100 being drawn from the supply roll 151, over the roller 317 and the folder 303, and between the guides 308. As can be seen in FIG. 7, the triangular configuration of the former 313 of the folder 303 causes the web 100 to begin to fold as it is drawn downward over the former 313. As shown in FIG. 9, the centerline of the web 100 (which corresponds to the score line 101) may not align with the centerline 333 of the former 313 as the web 100 is drawn over the former 313. This misalignment also can be seen in FIG. 8, which depicts the rearward side of the bagging machine 302 and the web 100. The misalignment between the longitudinal centerline of the web 100 and the centerline 333 of the former 313 is denoted by the arrows 315 in FIGS. 8 and 9. If the web 100 were to begin folding about the centerline 333 of the former 313 in this misaligned state, the guides 308 will impart a fold in the web 100 that does not coincide with the longitudinal centerline of web 100, which in turn will result in misalignment of the longitudinal edges 103 of the folded web 100. Such misalignment, as noted above, can interfere with the proper sealing of the longitudinal edge regions of the web 100 to each other.

As can be seen in FIGS. 8 and 9, the reduced bending resistance of the web 100 along its longitudinal centerline due to the score line 101 encourages the web 100 to fold about its longitudinal centerline as the web 100 becomes disposed between the guides 308, regardless of whether the longitudinal centerline of the web 100 is aligned with the centerline 333 of the former 313 as the web 100 passes over the vertex 334 and out of contact with the former 313. Without the score line 101, the geometry of the former 313 and the downward drawing of the web 100 over the former 313 would cause the web 100 to fold at a transverse location on the web 100 coinciding with the downstream vertex of the former 313, which corresponds to the downstream end of the former 313. By thinning or otherwise reducing the bending resistance of the web 100 along its longitudinal centerline, the web 100 is encouraged to fold about its longitudinal centerline when leaving the former 313, and this tendency of the web 100 to fold about its centerline can overcome the tendency to the web 100 to fold about a transverse location on the web 100 coinciding with the downstream vertex of the former 313 when the longitudinal centerline of the web 100 is misaligned with the centerline 333 of the former 313 as the web 100 reaches the downstream end of the former 313.

The reduced bending resistance of the web 100 about its longitudinal axis thus can reduce or negate the need for the bagging machine 302 to be equipped with automated features, such as actuators or a translatable frame, that move the supply roll 151 laterally, in the directions denoted by the arrows 306 in FIG. 7, to align the web 100 with the centerline 333 of the former 313. Instead, the reduced bending resistance of the web 100 about its longitudinal centerline allows the web 100 to pass over the former 313 in a misaligned state and still fold about its longitudinal centerline upon exiting the former 313.

The bagging machine 302 also includes a cutting and sealing unit 312 having sealer-cutters 316 that seal the partially-formed envelope 340 after the item 335 to be packaged has been inserted therein, and separate loaded and sealed envelope 340 from the remainder of the web 100 as discussed below. The bagging machine 302 also includes a loading area 322 located downstream of the intermediate area 320, between the guides 308 and the cutting and sealing unit 312.

The bagging machine 302 further includes spreaders 309 located in the loading area 322, downstream of the guides 308 and upstream of the cutting and sealing unit 312. The spreaders 309 are configured to spread, or maintain separation between the opposite sides of the partially-formed envelope 340 as the C-folded web 100 travels downward as denoted by the arrow 332 in FIG. 7 after passing between the guides 308, so that the item 335 to be packaged can be inserted into the envelope pocket. The spreaders 309 may be inserted into the partially formed envelope 340 so that spreaders 309 do not contact the fold line at the rear of the envelope 340. Alternatively, the spreaders 309 may be inserted into the partially formed envelope 340 so as to contact the fold line. The bagging machine 302 includes one or more rollers (not shown) to drive the web 100 into the loading area 322. Alternative embodiments of the bagging machine 302 can be equipped without this feature.

The bagging machine 302 also includes a labeling machine 331 located in the loading area 322. One of the spreaders 309 serves as a contact surface to facilitate the application of a label to the envelope 340 by the labeling machine 331. Both of the spreaders 309 can serve as contact surfaces in alternative embodiments.

A transverse seal is located along the bottom of the partially-formed envelope 340 currently being loaded, i.e., the partially-formed envelope 340 located loading area 322. As discussed below, the transverse seal was pre-formed during sealing of the envelope 340 produced immediately before the partially-formed envelope 340 currently being loaded. The transverse seal prevents the item 335 from falling downward after being loaded into the partially formed envelope 340.

The bagging machine 302 also includes a pulling device in the form of two opposing arms 310 that reciprocate between an inward position, shown in FIGS. 7 and 8, and an outward position (not shown). The arms 310 also translate between a lower position at the bottom of the sealing area 324 shown in FIGS. 7 and 8, and an upper position at the bottom of the loading area 322 (not shown). The arms 310 can grasp the lower end of the web 100, which coincides with the lower end of the partially-formed envelope 340, when the arms 310 are in their inward and upper position. Subsequent downward movement of the arms 310 pulls the bottom end of the web 100, and the partially-formed envelope 340 downward to the position shown in FIG. 7. The movement of the bottom edge of the web 100 also causes the web 100 to advance through the bagging machine 302. The pulling device can have a configuration other than the arms 310 in alternative embodiments. For example, alternative embodiments of the bagger 302 can be equipped with powered rollers that advance the web 100 through the bagging machine 302.

The cutting and sealing unit 312 of bagger 302 includes two opposing arms 314 that reciprocate between an inward position, shown in FIG. 7, and an outward position (not shown); and the two L-shaped sealer-cutters 316 each mounted on an end of a respective one of the arms 314.

After the pulling device, e.g., the arms 310, has drawn the bottom end of the web 100 (with the partially-formed envelope 340) downward to the position shown in FIG. 7, the arms 314 move to their inward positions, bringing the sealer-cutters 316 into contact with the partially formed envelope 340 located at the end of the web 100, i.e., the partially formed envelope 340 currently being loaded. The vertical portions or bars of the sealer-cutters 316 are configured to contact the longitudinal edge regions adjacent to the longitudinal edges 103 of the web 100, so that the longitudinal edges 103 are sandwiched between the vertical portions of the sealer-cutters 316. The horizontal portions or bars of the sealer-cutters 316 are configured to contact overlapping, transverse portions of web 100 that coincide with an upper end of the partially-formed envelope 340, so that the transverse portions are sandwiched between the horizontal portions of the sealer-cutters 316. The sealer-cutters 316 heat and apply pressure to the underlying portions of web 100, forming a longitudinally extending seal coinciding with the side edges of web 100 (and the now fully-formed envelope 340); and a transversely extending seal coinciding with the upper end of the now fully-formed envelope 340. The newly-formed longitudinal and transverse seals, along with the previously-formed transverse seal located at the bottom of envelope 340, close and seal the envelope pocket so that the packaged item 335 is retained in the envelope 340.

In embodiments where the web 100 is formed from paper or other material that cannot be heat sealed, closure-sealing elements formed from a heat-activatable material can be disposed on the web 100 at the locations at which the longitudinal and transverse seals are to be formed. Alternatively, the heat-activatable material can be applied as a flood coat to the surface on which the longitudinal and transverse seals are to be formed. The heat-activatable material can be, for example, a hot-melt adhesive or a heat-sealable material.

In alternative embodiments of the bagging machine 302, the cutting and sealing unit 312 can include, for example, a rolling longitudinal sealer and a horizontal bar in lieu of the arms 314 and sealer-cutters 316. In other alternative embodiments, the cutting and sealing unit 312 can include, for example, a horizontal sealer that rolls or slides across the web 100.

Alternative embodiments of the bagging machine 302 can include rollers to help draw the opposing sides of the web 100 together, to bring the longitudinal edges 103 of the web 100 into contact with each other.

Once the longitudinal and transverse seals have been formed, the sealer-cutters 316 can sever the newly formed envelope 340 from the web 100 by a suitable means such as cutting, the focused application of heat along the line of separation, pulling the envelope 340 away from the web 100, etc. For example, the transverse bars of the sealer-cutters 316 include three heating elements. A first heating element extends along the respective portions of each of the transverse bars and may heat to a first temperature. A second heating element extends along the transverse bars above the first heating element. Likewise, a third heating element extends along the transverse bars below the first heating element. The second and third heating elements heat to a second temperature that is lower than the first temperature to seal the web 100 without severing web 100. Because the line of separation runs through the transverse seal, the portion of the sealed transverse area that remains on the web 100 after the separation process forms the lower transverse seal for the next envelope 340 to be formed from the web 100.

The newly-formed and loaded envelope 340, upon being separated from the web 100, can drop onto a conveyor 318 or other means for transporting or holding the envelope 340.

The above description of bagging machine 302 is presented for illustrative purposes only. The webs 100, 200, and alternative embodiments thereof, can be processed using other types of bag makers. For example, the webs 100, 200, and alternative embodiments thereof, can be processed on the bagging machines disclosed in U.S. application Nos. 63/857,375; 63/857,390; 63/857,432; 63/857,449; and 63/857,306, each filed on Aug. 4, 2025. The contents of each of these applications are incorporated by reference herein in their entireties.

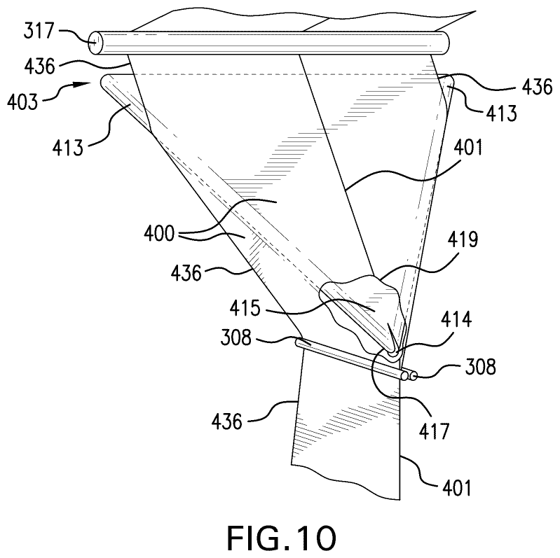

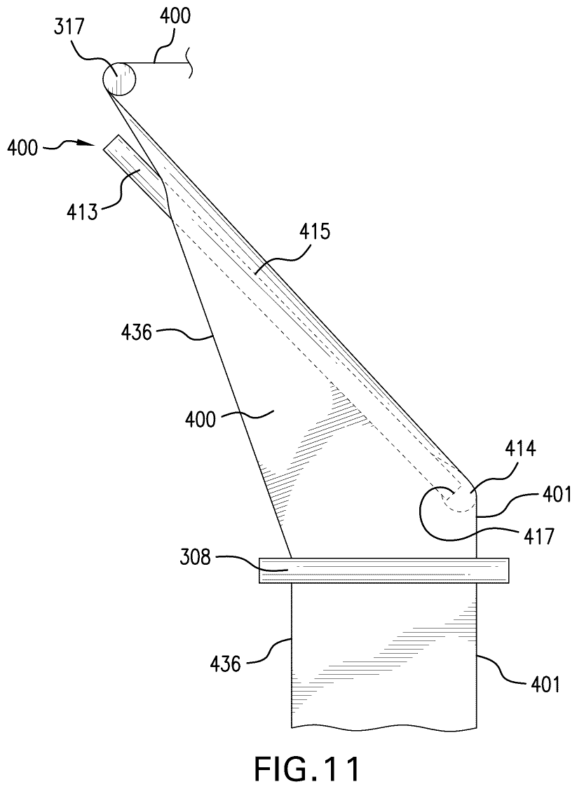

FIGS. 10 and 11 depict a folder 403. The folder 403 includes an alternative embodiment of the folder 303 in the form of a former 413. The folder 403 also includes a former guide 414 located on the former 413. The former 413 has a generally triangular configuration, with the opposite sides of the former 413 converging at a vertex 417 located at the downstream end of the former 413.

The folder 403 is depicted as folding a web 400 formed from a single ply of paper. The web 400 has a score line 401 formed therein and extending along the longitudinal centerline of the web 400. The folder 403 is disclosed as folding the web 400 for illustrative purposes only. The folder 403 also can be used to fold the web 100, the web 200 and the other alternative embodiments of the web 100 discussed above, and other types of scored webs, including webs with one or more score lines formed at locations on the web other than the longitudinal centerline thereof.

The forming guide 414 is fixed to the former 413 at and near the vertex 417 and defines the converging sides of the former 413. The forming guide 414 is elongated, with the lengthwise dimension of the forming guide 414 coinciding with the direction of the web path. The forming guide 414 is located along the longitudinal centerline of the former 413, with the longitudinal centerline coinciding with the general direction of the web path. The forming guide 414 projects from an upper surface 415 of the former 413, with the elevation of the top of the forming guide 414 increasing progressively in the downstream direction. The top of the upstream portion of the forming guide 414 can be straight and angled upward as shown in FIG. 11. The downstream portion of the forming guide 414 is blunt, e.g., rounded, and overhangs the former 413. The forming guide 414 can have other shapes in alternative embodiments.

The thickness, or transverse dimension of the forming guide 414 is small in relation to the other dimensions of the forming guide 414 so that the forming guide 414 has a thin, elongated configuration resembling a fin, which encourages the score line 401 in the web 400 to track the forming guide 414 as the web 400 is drawn over the forming guide 414. The noted configuration of the forming guide 414 also encourages the web 400 to fold about the score line 401 as the web 400 is drawn over the forming guide 414. The forming guide 414 has sufficient thickness, however, to avoid cutting or otherwise damaging the web 400. In some embodiments, the top of the forming guide 414 can be rounded or smoothed in the transverse direction, to reduce the potential for the web 400 to be damaged as it is drawn over the forming guide 414. In some embodiments, the forming guide 414 can be formed from a low-friction material or can be coated with a low-friction material such as polytetrafluoroethylene (PTFE), to reduce the potential for damage to the web 400.

The thickness of the forming guide 414 can be, for example, about 1/16-inch to about ¾-inch. In some embodiments, the ratio of the length, or longitudinal dimension to the thickness of the forming guide 414 can be about equal to or greater than 10:1. In some embodiments, the length to thickness ratio can be between 10:1 and 100:1. In some embodiments, the length to thickness ratio can be between 10:1 and 500:1. The above values for the thickness and the length-to-thickness ratio of the forming guide 414 are presented for exemplary purposes only. The optimal thickness and the optimal length-to-thickness ratio are application-dependent, and can vary with factors such as the type of materials from which the forming guide 414 and the web 400 are formed, the thickness of the web 400, the tension and speed of the web 400 as it passes over the folder 403, etc.

The forming guide 414 is configured as a solid and continuous structure. Alternative embodiments of the forming guide 414 can be hollow and/or discontinuous. For example, alternative embodiments of the forming guide 414 can be configured as a wire or a thin rod suspended or otherwise supported above the upper surface 415 of the former 413. Other alternative embodiments of the forming guide 414 can be configured as a thin wheel or roller, and or series of thin wheels or rollers. Other alternative embodiments of the forming guide 414 can be configured as a thin belt configured to move with the web 400. In other alternative embodiments, the forming guide 414 can be integrally formed with the former 413. For example, in one such embodiment, the upper surface 415 of the former 413 can be shaped so that the upper surface 415 is elevated at the downstream end of the former 413 and along the longitudinal centerline of the former 413 so as to encourage the web 400 to fold along the score line 401. In some embodiments, the folder 403 can include multiple forming guides located along the longitudinal centerline of the former 413.

The web 400 is partially folded as it moves over the former 413 and the forming guide 414 of the former 413. As discussed above in relation to the folder 303, after leaving the former 413 in a partially-folded state, the closely-spaced guides 308 of the bagging machine 302 urge the opposing sides of the web 400 toward each other, further folding the web 400 into the C-folded configuration shown in FIGS. 7 and 8.

The reduced bending resistance of the web 400 along its longitudinal centerline due to the score line 401 encourages the web 400 to fold about its longitudinal centerline as it travels over the former 413 and is pulled, in tension, toward the guides 308. The thin, elongated configuration of the forming guide 414 encourages the score line 401 to track the forming guide 414 and thus helps to center the web 400 on the former 413 in a direction transverse to the material path. Also, due to the projection of the forming guide 414 above the upper surface 415 of the former 413, and the thin, elongated configuration of the forming guide 414, the forming guide 414 slightly lifts the web 400 along the approximate centerline of the web 400 and encourages the web 400 to fold about the score line 401. Because the score line 401 corresponds to the centerline of the web 400, the folding of the web 400 about the score line 401, in conjunction with the contact between the web 400 and the forming guide 414, exert a centering effect on the web 400 in the transverse direction and thereby help to correct misalignment between the longitudinal centerline of web 400 and the centerline of the former 413 that may be present as the web 400 reaches the former 413, which in turn encourage folding of web 400 about its longitudinal centerline as the web 400 becomes disposed between the guides 308, regardless of whether the longitudinal centerline of the web 400 is initially aligned with the centerline of the former 413. As discussed above in relation to the web 400, folding the web 400 about its longitudinal centerline helps to ensure that the longitudinal edges 436 of the web 400 are aligned during the subsequent sealing process so that the sealing process can be properly performed. The score line 401, in conjunction with the forming guide 414, thus encourage the web 400 to self-center with respect to its longitudinal centerline as web 400 moves over the former 413 and between the guides 308, and is folded into its final C-shaped configuration.

The web 400 can be supplied as a supply unit in a high-density configuration such as a rolled or fan-folded configuration.

Alternative embodiments of the bagging machine 302 can be configured to form the score line 401 in the sheet material being provided to the bagging machine 302 so that the web 400 is formed, in part, on the bagging machine. For example, alternative embodiments of the bagging machine 302 can include a blade or other device for forming a shallow cut or other feature in the sheet material upstream of the folder 403, to form the score line 401.

In some embodiments, the web 400 can have a heat-activatable material applied to one side thereof. The heat-activatable material can be, for example, a heat-sealable material. The heat-sealable material can be used, for example, to form the seals produced by the cutting and sealing unit 312 of the bagging machine 302 when forming the web 400 into front-loading envelopes as discussed above. The heat-sealable material can be applied as a flood coat. Alternatively, the heat-sealable material can be applied in discrete bands at the locations on the web 400 at which the seals are to be formed. A supply unit of the web 400, with the score line 401 formed therein and the heat-sealable material applied thereto, can be supplied in a high-density configuration such as a roll or a fan-folded stack. Alternatively, in applications where the bagging machine 302 is configured to form the score line 401, the supply unit can be provided with the heat-sealable material applied to the web 400, and without the score line 401 formed on the web 400. The heat-activatable material can be a material other than a heat-sealable material in alternative embodiments. For example, the heat-activatable material can be a hot-melt adhesive.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described embodiments. Rather, the scope of the present solution should be defined in accordance with the following claims and their equivalents.

What is claimed is:

1. A system for forming envelopes, comprising:
a web having a score line extending along the web in a longitudinal direction of the web and configured to reduce a resistance of the web to bending about an axis coinciding with the score line; and
a bagging machine, comprising:
a folder including a former configured to fold the web as the web is drawn over the folder;
a web guide located downstream of the former and having opposing guide surfaces configured to urge longitudinal edges of the envelope toward each other to further fold the web as the web passes through the web guide so that a first portion of the web overlaps a second portion of the web to form an envelope pocket of an envelope, and
a sealing device having two opposing sealing surfaces configured to apply a sealing pressure to a sealing area on the web to form a seal between the first and second portions of the web.

2. The system of claim 1, wherein the score line is configured to cause the web to fold about the score line as the web is drawn over the former and through the web guide.

3. The system of claim 1, wherein the score line defines a living hinge on the web.

4. The system of claim 1, wherein a thickness of the web is locally reduced along the score line.

5. The system of claim 4, wherein the portion of the web of having the reduced thickness defines a valley.

6. The system of claim 1, wherein the score line is one or more of a cut, a crease, a fold, an abrasion, a sealed region, and a crushed region.

7. The system of claim 1, wherein:
the first and second portions of the web each have a width in a direction transverse to the longitudinal direction of the web; and
the width of the first portion of the web is about equal to the width of the second portion of the web.

8. The system of claim 1, wherein the score line is configured to cause the longitudinal edges of the web to align when the web is folded about the score line as the web is drawn over the former and through the web guide.

9. The system of claim 8, wherein the score line is located along a longitudinal centerline of the web.

10. The system of claim 8, wherein the score line causes the longitudinal edges of the web to align when the web is folded about the score line as the web is drawn over the former and through the web guide while web and the former are misaligned.

11. The system of claim 10, wherein the score line causes the longitudinal edges of the web to align when the web is folded about the score line as the web is drawn over the former and through the web guide while a longitudinal centerline of the web and a centerline of the former are misaligned.

12. The system of claim 1, wherein the sealing area includes longitudinal edge regions of the web, the longitudinal edge regions being adjacent to respective longitudinal edges of the web.

13. The system of claim 1, wherein:
the web includes paper;
the web includes a bonding element located in the sealing area and configured to form the seal between the first and second portions of the web;
the bonding element is a heat-activatable material; and
the bagging machine further includes a heating element configured to apply sufficient heat to the sealing area to activate the heat-activatable material.

14. The system of claim 1, wherein:
the web includes a first layer, a second layer, and a third layer;
the second layer is positioned between the first and third layers; and
the first, second, and third layers are compressed along the score line.

15. The system of claim 14, wherein:
the first, second, and third layers include plastic film; and
the first, second, and third layers are sealed to each other along the score line.

16. The system of claim 14, wherein:
the second layer is positioned between the first and third layers and includes padding or a thermally insulating material; and
the padding or thermally insulating material is crushed along the score line.

17. The system of claim 1, wherein:
the folder further includes a forming guide located on the former and configured to engage the web; and
the score line and forming guide cooperate to center the web on the folder.

18. A bagging machine for forming envelopes from a web having a score line extending along the web in a longitudinal direction of the web and configured to reduce a resistance of the web to bending about an axis coinciding with the score line, the bagging machine comprising:
a folder including a former, and a forming guide located on the former and configured to engage the web, the former and the forming guide configured to fold the web as the web is drawn over the former;
a web guide located downstream of the former and having opposing guide surfaces configured to urge longitudinal edges of the envelope toward each other to further fold the web as the web passes through the web guide so that a first portion of the web overlaps a second portion of the web to form an envelope pocket of an envelope; and
a sealing device having two opposing sealing surfaces configured to apply a sealing pressure to a sealing area on the web to form a longitudinal seal and a transverse seal between the first and second portions of the web.

19. A web configured for use with a bagging machine, the web including a score line extending along the web in a longitudinal direction of the web and configured to reduce a resistance of the web to bending about an axis coinciding with the score line.

20. The web of claim 19, wherein the web includes a bonding element configured to form a longitudinal seal between overlapping longitudinal edge regions of the web when the web is folded about the score line.
